(19) United States
(12) Patent Application Publication
(10) Pub. No.: US 2013/0007009 A1
(43) Pub. Date: Jan. 3, 2013

(54) Expertise Tagging and Project Membership Suggestion

(75) Inventors: Nicholas Caldwell, Bellevue, WA (US); Saliha Azzam, Redmond, WA (US); Jonathan C. Ludwig, Kirkland, WA (US); Venkat Pradeep Chilakamarri, Redmond, WA (US); Courtney Anne O'Keefe, Bellevue, WA (US)

(73) Assignee: MICROSOFT CORPORATION, Redmond, WA (US)

(21) Appl. No.: 13/171,155

(22) Filed: Jun. 28, 2011

(51) Int. Cl. G06F 17/30

(52) U.S. Cl. 707/748; 707/736; 707/E17.014

(57) ABSTRACT

Automatically tagging individual users for identifying expertise or other relevant skills associated with the individual users based on various sources of information used or interacted with by the users is provided. After expertise tags are established for an individual user, the expertise tagging and other information about the user's profile and computing activities may be used for automatically suggesting a user for membership in one or more other project groups or workspaces that may be a good fit for the user's expertise or other relevant skills.

### BACKGROUND

Within any number of business, social, or academic enterprises, various members of a given enterprise may have varying levels of expertise associated with different topics or concepts. For example, one member of a given enterprise may have specialized expertise associated with object oriented programming. Ideally, a member of the enterprise desiring the assistance of the member with the specialized expertise could use a keyword driven search to find contact information for the enterprise member having the specialized expertise, however, such a keyword driven search would require that people within the enterprise are tagged with keywords associated with their particular expertise. Typically, members of various enterprises are reluctant to tag themselves with such identifying information which makes performing searches on the members a problem.

In addition, when a member of a given enterprise is new to the enterprise, one of the first tasks that the member often performs is signing up for appropriate mailing lists, work groups, and projects. This task is complicated by various factors. For example, the user may not know what resources and projects are initially available, and therefore, the user does not know those resources and projects to which the user should request access. Moreover, even if the user knows what resources and/or projects are available, the user still must determine which resources and projects are relevant to the user's daily tasks and work.

It is with respect to these and other considerations that the present invention has been made.

### SUMMARY

Embodiments of the present invention solve the above and other problems by automatically tagging individual users for identifying expertise or other relevant skills associated with the individual users based on various sources of information used or interacted with by the users. According to embodiments, keyword tags are automatically associated with individual users by monitoring electronic mails they send, documents they create, edit, or otherwise interact with, social networks they utilize, others they interact with, and other sources of information. A keyword ranking application ranks keywords generated for individual users, and highly ranked tags are suggested to the individual users as expertise tags. For example, a suggested expertise tag of “software developer” may be suggested for a given user to allow other users to identify him or her for a given software development project. According to one embodiment, the expertise tagging may take the form of a set of keywords or a summary of one or more keywords that is indicative of expertise or skill sets associated with the given user that may be searchable for finding expertise information for the user.

After expertise tags are established for an individual user, the expertise tagging and other information, for example, the user's position on organization charts, the user's activities, and information about project groups or workspaces to which the user belongs, may be used for automatically suggesting a user for membership in one or more other project groups or workspaces that may be a good fit for the user's expertise or other relevant skills.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1A illustrates a system architecture and process flow for automatically generating expertise tags for individual users associated with one or more electronic project workspaces.

FIG. 1B illustrates a computer screen shot of a user interface component for presenting expertise tags to a user.

FIG. 2A illustrates a system architecture and process flow for automatically suggesting membership of a user in one or more electronic project workspaces.

FIG. 2B illustrates a computer screen shot of a user interface component for recommending membership of a user in one or more electronic project workspaces.

FIG. 3 illustrates a system architecture for providing suggested expertise tags and suggested project membership to various client devices.

FIG. 4 is a block diagram of a system including a computing device with which embodiments of the invention may be practiced.

### DETAILED DESCRIPTION

As briefly described above, embodiments of the present invention are directed to automatically tagging individual users for identifying expertise or other relevant skills associated with the individual users based on various sources of information used or interacted with by the users. Expertise tagging may include one or more keywords, a set of keywords or a summary of keywords (all searchable) for associating a given expertise or skill set to various users. After expertise tags are established for an individual user, the expertise tagging and other information about the user's profile and computing activities may be used for automatically suggesting a user for membership in one or more other project groups or workspaces that may be a good fit for the user's expertise or other relevant skills. Other users may find a tagged user when searching for a particular area of expertise that relates to the tags associated with various users.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

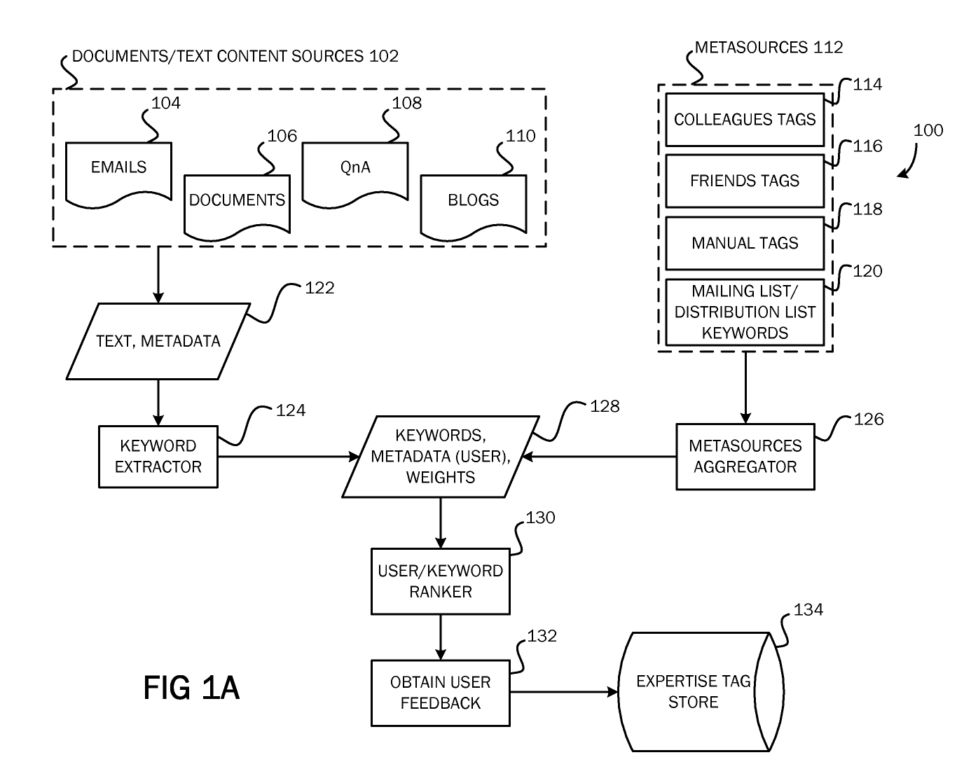

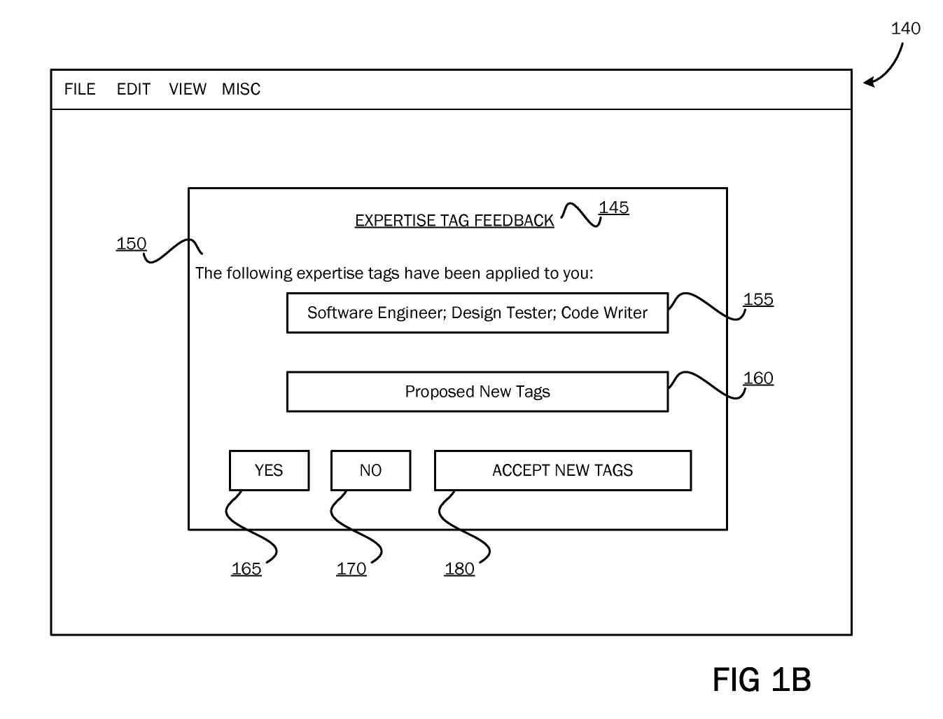

FIG. 1A illustrates a system architecture and process flow for automatically generating expertise tags for individual users associated with one or more electronic project workspaces. According to embodiments, an expertise tag is developed and applied to an individual user based on a variety of information items associated with the user. According to one embodiment, information associated with an individual user that may be utilized for developing and applying an expertise tag to the individual user may be categorized into two types of sources. First, textual content is that is authored by the user, for example, electronic mail items authored by the user, text messages authored by the user, documents authored by the user, blogs written or responded to by the user, questions and answers written and/or responded to by the user contained in a variety of sources, and the like may be processed by a keyword extractor that extracts important terms or keywords from the text for providing helpful information about the expertise of the user.

A second category of information that may be used in defining the expertise of an individual user includes information that describes the user through one or more profiles associated with the user and/or associated with a project workspace environment. Other such information includes user-entered expertise tags, user approval expertise tags applied to them by other users, expertise information for the user's contacts or colleagues, descriptions of mailing lists and forums subscribed to by the user, or project workspaces to which the user belongs or to which the user has subscribed. Keywords extracted from these types of information may then be ranked by a keyword ranker based on various factors including the type of source and a confidence score associated with each type of source. Highly ranked keywords may then be outputted to the user in a user interface to allow the user to provide feedback on expertise tagging applied to the user. For example, if documents generated by the user contain keywords of “software designer” or “software engineer” and if information from profile information associated with the user likewise includes the terms “software designer” or “software engineer,” then an expertise tag of “software designer” or “software engineer” may be suggested to the user as expertise tagging that will be applied to the user to allow others in the user's organization or outside the user's organization to interact with the user based on the user's applied expertise tagging.

Referring still to FIG. 1A, the above process is illustrated and described. The documents/text content sources 102 are illustrative of textual content authored by an individual user that may provide helpful information in developing and applying expertise tags to the user. User emails 104 is illustrative of a collection of electronic mails sent and received by an individual user containing a variety of information that may be utilized for developing expertise keywords about the user. For example, in any given electronic mail message, identification of sender, identification of recipients, subject lines, and the text of the email may contain various keywords that may be used for determining expertise or other relevant skills about an individual user. For example, if a number of electronic mail items sent by the user have the terms “software,” “design,” “project,” “management,” and the like, such keywords may be extracted, as described below, and may be used for suggesting expertise tags for the subject user.

User documents 106 are illustrative of any documents, for example, letters, memoranda, specifications, spreadsheet documents, slide presentation documents, and the like authored by an individual user that may contain keywords that will be helpful in applying expertise tagging to the user. For example, if a number of documents authored by the user contain keywords, as described above, for example “software,” “designer,” and the like, such keywords may be used subsequently for applying expertise tagging to the subject user. The question and answers repository 108 is illustrative of stored question and answer pairings associated with a user, for example, where a stored question and answer pairing was asked by or answered by the subject user. Such question and answers may often be directed to work projects associated with the user, technologies in which the user has expertise or involvement, and the like. Thus, such question and answer pairings may provide many possible keywords that may be reviewed for application of expertise tagging to the subject user.

Blogs 110 are illustrative of any other forum in which the user may author text-based communications or documentation that may include keywords that may be used for defining and tagging the expertise or other relevant skills of the user. For example, the blogs repository 110 may be illustrative of Internet-based chat forums, organization discussion boards, and the like through which the user may author various text-based documents or communications and from which keywords may be extracted for use in applying expertise tagging to the user.

According to embodiments, text and associated metadata 122 from each of the aforementioned text content sources may be extracted and may be passed to a keyword extractor 124 for extracting various keywords from the text content sources for ultimate use in developing and applying expertise tagging to the subject user. According to one embodiment, the keyword extractor includes a text processing operation for breaking received text content into individual text components (e.g. words, terms, numeric strings, etc.) that may be used for developing expertise tags. Received text content and metadata are analyzed and formatted as necessary for text processing described below. According to embodiments, the text content and metadata analysis may be performed by a text parser operative to parse text content and metadata for processing the text into one or more text components (e.g., sentences and terms comprising the one or more sentences). For example, if the text content and metadata are formatted according to a structured data language, for example, Extensible Markup Language (XML), the text content and metadata analysis may include parsing the retrieved text content and metadata according to the associated structured data language for processing the text as described herein. For another example, the text content and metadata may be retrieved from an online source such as an Internet-based chat forum where the retrieved text may be formatted according to a formatting such as Hypertext Markup Language (HTML). According to embodiments, the text content and metadata analysis may be include formatting the retrieved text content and metadata from such a source so that it may be processed for conversation topics as described herein.

A text processing application may be employed whereby the text is broken into one or more text components for determining whether the received/retrieved text may contain terms that may be formed expertise tags or that may be used for searching for stored expertise tags. Breaking the text into the one or more text components may include breaking the text into individual sentences followed by breaking the individual sentences into individual tokens, for example, words, numeric strings, etc.

Such text processing is well known to those skilled in the art and may include breaking text portions into individual sentences and individual tokens according to known parameters. For example, punctuation marks and capitalization contained in a text portion may be utilized for determining the beginning and ending of a sentence. Spaces contained between portions of text may be utilized for determining breaks between individual tokens, for example, individual words, contained in individual sentences. Alphanumeric strings following known patterns, for example, five digit numbers associated with zip codes, may be utilized for identifying portions of text. In addition, initially identified sentences or sentence tokens may be passed to one or more recognizer programs for comparing initially identified sentences or tokens against databases of known sentences or tokens for further determining individual sentences or tokens. For example, a word contained in a given sentence may be passed to a database to determine whether the word is a person's name, the name of a city, the name of a company, or whether a particular token is a recognized acronym, trade name, or the like. As should be appreciated, a variety of means may be employed for comparing sentences or tokens of sentences against known, words, or other alphanumeric strings for further identifying those text items.

After the text content sources and associated metadata are broken into individual text components, as described above, the keyword extractor may collect keywords for use in developing and applying expertise tagging to the subject user. As part of the collection of keywords, certain terms, for example, basic articles such as “a,” “and,” “the,” and the like may be discarded along with other words that are not useful in developing expertise tagging. According to one embodiment, a keyword store may be utilized by the keyword extractor for comparing keywords extracted from retrieved text content sources for determining which keywords extracted from the text content sources should be kept for use in developing expertise tagging and for determining which keywords should be discarded. For example, the keyword store utilized by the keyword extractor may include a list of keywords commonly utilized for expertise tagging as well as a list of words and terms that are seldom or never used in developing expertise tagging. Extracted keywords are passed to the keywords, metadata and weights component operation 128 for combination with metadata information, as described below.

As briefly described above, in addition to keywords extracted from various text content sources, metadata associated with the user and associated with other users and sources of information related to the user may also be used for developing and applying expertise tagging to an individual user. The meta-sources repository 112 is illustrative of a variety of metadata sources that may provide information useful in developing and applying expertise tagging to an individual user. For example, colleague tags 114 is illustrative of expertise tagging applied to various colleagues of the user, as defined by other users and common project workspaces with the subject user, other users to which the user regularly communicates, other users in the same product development team as the user, and the like. Metadata indicating expertise tagging associated with such other users may be very helpful in developing expertise tagging for the subject user including ranking keywords extracted from text content sources as to their weight relative to each other and developing expertise tagging for the subject user.

Expertise tags or personal tags 116 applied to friends of the user may provide helpful information regarding expertise tagging that may be developed for the subject user. For example, if friends to which the user associates through social networking sites, friends lists on electronic mail systems, and the like are tagged with various expertise tagging, metadata associated with such expertise tagging may be useful and further defining expertise tagging that may be applied to the subject user. Manual tag entries 118 are illustrative of any manual metadata entered by the user that may be valuable in determining expertise tagging for the user. For example, manual entries may include entries entered by the user on company forms, information entered by the user on user profiles for company databases, social networks, and the like. Such information is valuable because such information is entered directly by the user and provides a good source of information for defining expertise tagging for the user. For example, if a company form is prepared by the user wherein the user lists various types of expertise, skills, or experience, such information may be useful in developing expertise tagging for application to the subject user. Mailing lists/distribution list keywords 120 is illustrative of metadata associated with various communications sent to, received by, responded by, or otherwise interacted with by the user that similarly may provide useful information for developing and applying expertise tagging to the subject user.

At the meta-sources aggregator component/operation 126, metadata sources are processed into individual text components in a similar manner as described above for the text content sources. That is, metadata information is broken into individual terms that may be used for developing and applying expertise tags to the subject user. Once the keywords or terms are aggregated from the various meta-sources they may be passed to the keywords, metadata component/operation 128. In addition to passing the individual keywords and terms extracted from the text content sources and metadata sources, any weighting to those keywords and terms that is available from the sources from which the terms are extracted is also aggregated. For example, manual entries 118 may be weighted higher than information from the friends tags 116 because the manual entries are entered directly by the subject user and may be associated with a higher confidence of having accurate information that may be used for developing and applying expertise tagging to the user. Likewise, documents 106 authored by the subject user may receive a higher weighting and/or confidence score than information obtained from blog 110 that may contain text entered by a variety of different users.

Once keywords and terms are extracted from text content sources and meta-sources, as described above, the extracted keywords and terms are passed to the user/keyword ranker component/operation 130 for developing a ranked list of extracted keywords and terms. As described above, weights and confidence scores may be applied to various sources of keywords and terms, and weights and confidence scores may likewise be applied to various keywords and terms. For example, as described above, information manually entered by a user may receive a high weighting and/or confidence score owing to the source of the entered information. Information received from documents authored directly by the user likewise may receive a high weighting and/or confidence score. On the other hand, information from sources containing text or data entered by a variety of users, for example, a blog site (for example, blogs not written by the subject user) or Internet-based chat forum may receive a lower ranking and/or confidence score because information contained from such sources may not be easily associated with the subject user as opposed to other users contributing text to such sources.

In addition, weighting and/or confidence scores may be applied to various keywords and terms. As described above, the keyword extractor may utilize lists of previous extracted and weighted keywords and terms stored in a keyword and term store for obtaining weights and/or confidence scores associated with certain keywords and/or terms. For example, a keyword of “engineer” may receive a higher weighting and/or confidence score than a keyword or term of “software”, because the term “engineer” indicates a particular skill or expertise, whereas the term “software” may indicate a product used by a subject. On the other hand, combinations of keywords or terms, for example, “software engineer” may receive a higher weighting and/or confidence score, because the combination of such keywords or terms further defines an expertise or skill that may be associated with a subject user.

After the extracted keywords and terms are ranked, highly ranked keywords and/or terms, for example, the top ten keywords or terms, the top five keywords or terms, or the like may be presented to the user at the user feedback operation/component 132. As will be described below with reference to FIG. 1B, the candidate expertise tags may be presented to the user in a user interface component that allows the user to accept or reject candidate expertise tags, or that allows the user to provide replacement expertise tags for those automatically developed for the user, as described herein. Once expertise tags proposed to the user, or received from the user are accepted, the accepted expertise tags may be applied to profiles associated with the user and may be stored in the expertise tags store 134 for subsequent use in association with the user.

As briefly described above, expertise tags associated with a given user may be more than single keywords identifying a particular expertise. According to embodiments, the expertise tags may include a set or collection of keywords, or a summary of a set or collection of keywords that may be automatically stored for a given user or that may be stored after review, modification or replacement by a reviewing user as described below with reference to FIG. 1B. Stored expertise tags, whether single keywords, sets or collections of keywords or summaries of keywords, may be searchable by other users when they are looking for a particular area of expertise or skill associated with one or more users. For purposes of description, an expertise knowledge indication may include one or more expertise keyword tags, a set or collection of expertise keywords or a summary of expertise keywords that may be applied to or otherwise associated with a given user.

FIG. 1B illustrates a computer screen shot of a user interface component for presenting expertise tags to a user. As described above, once highly ranked keywords and/or terms are extracted and ranked for a subject user, those highly ranked keywords and/or terms may be provided to the user in a user interface component 140 to allow the user to provide feedback about the proposed expertise tags. The user interface component 140 includes an expertise tag feedback component 145 that may be launched and displayed to the user on any suitable display screen in association with any software application capable of launching and displaying a user interface component for interacting with a user. A statement 150 such as “The following expertise tags have been applied to you:” may be provided above a text box or field 155 in which candidate expertise tags may be presented to the user. For example, the candidate expertise tags may be the top five, top ten, or the like keywords and/or terms extracted and ranked from the text-based and metadata-based sources, described above.

For example, the tags “software engineer,” “design tester” and “code writer” are illustrated in the text box 155 as candidate expertise tags that may be applied to the subject user. According to embodiments, the user may accept or reject the candidate expertise tags, or the user may propose replacement expertise tags in the text box or field 160, followed by selection of the “Accept New Tag” button 180. According to one embodiment, a menu, for example, a drop down menu, associated with the proposed tag text box or field 160 may be provided to allow the user to select from other expertise tags that have been developed and applied to other users. In addition, the user may make inline revisions/corrections to the candidate expertise tags displayed in the text box/field 155, followed by selecting the button 180 for submitting the revised/corrected tags. If the user accepts candidate expertise tags, or if the user submits replacement expertise tags, the accepted or replacement expertise tags may be stored in the expertise tags store 134, as described above. If the user rejects the candidate expertise tags, but provides no replacement expertise tags, then no expertise tags will be applied to the user until additional expertise tags are subsequently developed and presented to the user.

According to embodiments, once expertise tagging is developed and applied to a user, as described above, expertise tagging for the user along with other information about the user, for example, the user's membership or association with others having membership in one or more organization charts, the user's activities, for example, the documents they read, or the other users with which they communicate, and information about existing project or workspace memberships may be used for developing a recommendation that the user should be included in a particular project membership. For example, if expertise tagging, organizational chart information, activities, information about existing memberships, and other useful information indicates that a user should be recommended for membership in a particular project associated with the development of a new software product for processing sales data, then a recommendation to the user for membership in such a group may be offered to the user via a user interface component that may be accepted, rejected, or modified by the user.

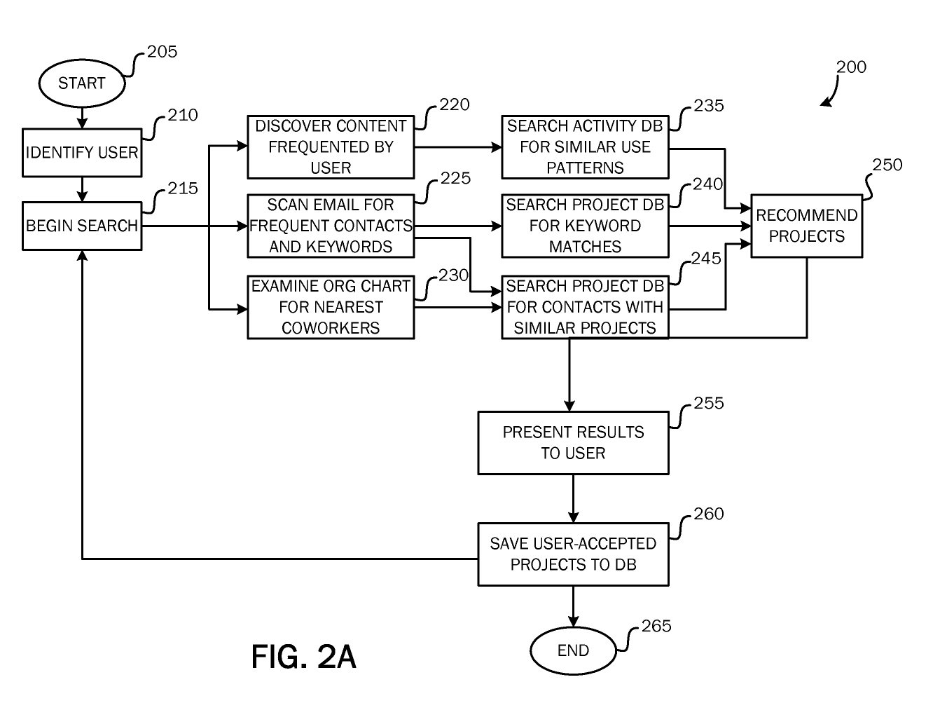

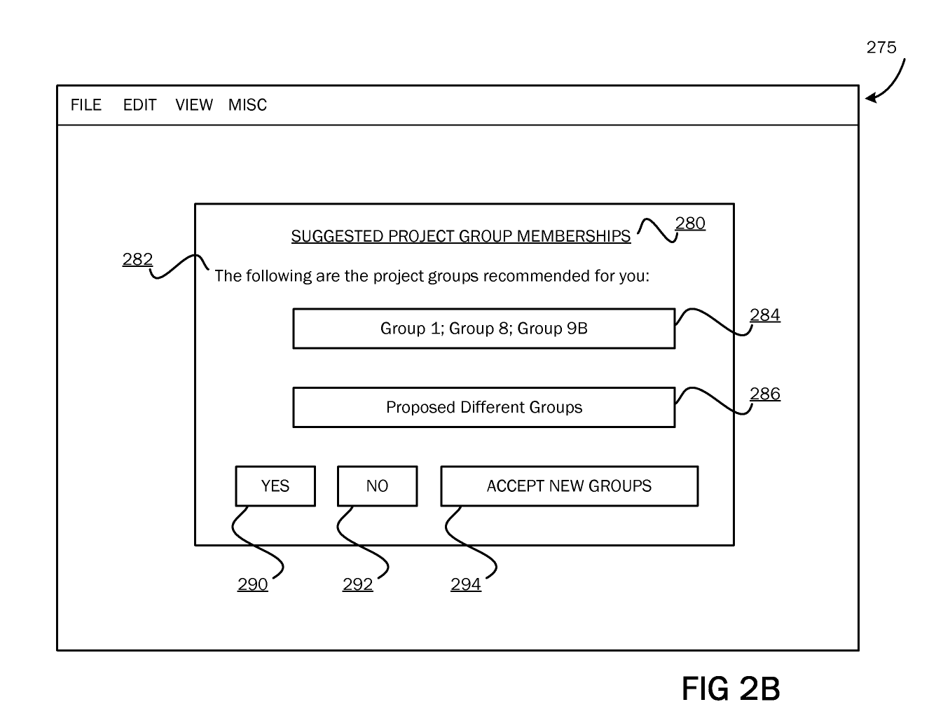

FIG. 2A illustrates a system architecture and process flow for automatically suggesting membership of a user in one or more electronic project workspaces. The method/project recommendation system 200 begins at start operation 205 and proceeds to operation 210 where the subject user is identified either by user input, or by automatic identification of the user based on the user's current activity. For example, when the user logs into an electronic mail system, signs into a corporate intranet, and the like, presence of the user may be used for identifying the user and for beginning the process of developing project membership suggestions for the user, as described below. During the identification of the user, information associated with the user is gathered for analysis, as described below. For example, expertise tagging developed for and applied to the user, as described above is assembled, organization charts including the user, or including the user's managers, peers, or others reporting to the user may be assembled, text sources and metadata sources described above with reference to FIG. 1A may be assembled for the user which provide an indication of user activities, and information about projects to which the user is already associated including information about other members of such projects and about content associated with other such projects may be assembled.

At operation 215, a search for project memberships that may be suggested to the user begins. At operation 220, content frequently used by the subject user may be parsed for keywords and terms that may be compared to keywords and terms associated with various project teams or workspaces that may be suggested to the user. At operation 225, electronic mail items for frequent contacts, and keywords associated with such electronic mail items and frequent contacts may be parsed for use in project membership searches. At operation 230, organization charts that may provide information about co-workers nearest to the subject user in the organization chart, as well as, other users associated with the organization chart may be parsed for obtaining keywords and terms that may be used for searching similar keywords and terms associated with various projects and associated with other users who are currently members of such projects. As should be appreciated, the keywords and terms for information described with respect to operations 220, 225, 230 may include the same keywords and terms extracted from the text content sources and meta-sources utilized for developing and applying expertise tagging to the subject user, as described above with reference to FIG. 1A.

At operation 235, keywords and terms associated with text content activity, for example, documents generated or edited by the subject user, electronic mail items sent or received by the subject user and the like may be used for searching a keyword or term database associated with various projects that may be suggested to the subject user for similar keywords and terms. For example, if keywords or terms such as “project AB” are found in various documents of the subject user and are likewise found in various documents associated with a particular project workspace, that project workspace may ultimately be suggested to the subject user for membership.

At operation 240, keywords and terms extracted from communications such as electronic mail items, text messages, and the like associated with various other users, for example, frequently used contacts may be used for similarly searching a database of keywords and terms associated with various project workspaces. For example, if one or more user identifications are extracted from various electronic mail items and such user identifications match one or more users who are currently associated with or who are members of a particular project workspace, that project workspace might be suggested to the subject user for membership.

At operation 245, information from organization charts, information about the subject user's membership in existing project workspaces, and the like may be used for searching databases of keywords and terms associated with various project workspaces for matching the subject user to one or more particular project workspaces. For example, if one or more users are identified in close proximity to the subject user on an organizational chart, and if those one or more users are identified as members of a particular project workspace, then that project workspace may be suggested to the subject user for membership.

At operation 250, information from each of the above-described database searches, including information from combinations thereof, may be used for developing project membership recommendations. For example, if keywords or terms from documents prepared by the subject user are found in documents stored in association with a particular project workspace, and if members of the subject user's frequently used contacts are identified with the particular project workspace, and if users on the subject user's organization chart are also indicated as members of the particular project workspace, then that project workspace may have a high ranking or high confidence as a suggested project workspace for the subject user. On the other hand, if a member of the subject user's organization chart is identified in association with a particular project workspace, but no other information associated with the subject user, for example, text content, communications content, or the like, is matched between the user and information associated with that project workspace, then recommendation of the subject user to that project workspace may be ranked lower and/or receive a lower confidence score.

Thus, at operation 250, recommendations for membership in one or more project workspaces for the subject user may be ranked, and at operation 255, highly ranked project membership recommendations may be presented to the user via a user interface component, as described below with reference to FIG. 2B, to allow the user to accept or reject the suggested project membership, or to allow the user to selectively propose membership in a different project workspace. At operation 260, project memberships accepted by the user may be stored. As should be appreciated, storage of project memberships accepted by the user may be used for subsequent analysis of other users in terms of suggesting membership of other users to the same or similar project workspaces. The method ends are operation 265.

FIG. 2B illustrates a computer screen shot of a user interface component for recommending membership of a user in one or more electronic project workspaces. The user interface 275 may be used to present suggested project memberships to the subject user and to allow the user to accept, reject, or propose alternate project membership. The suggested project group membership user interface component 280 may include a statement 282 such as “The following are the project groups recommended for you:” A text box/field 284 is provided for listing project workspaces or groups recommended to the user, as described above with reference to FIG. 2A. For example, example groups of “Group 1, Group 8 and Group 9B” are recommended to the subject user. According to embodiments, the user receiving the example recommendations may accept the example recommendations, and the accepted recommendations will be stored for the user, as described above, and the user will be associated with the accepted project group memberships. Alternatively, the user may make inline revisions/corrections to the candidate project recommendations displayed in the text box/field 284, followed by selecting the button 294 for submitting the revised/corrected tags.

If the user rejects membership in the suggested project group memberships, the user may receive subsequent project membership recommendations based on additional activities, for example, additional documents, electronic communications, and the like, developed or conducted by the user. Alternatively, the user may propose a different project workspace or group for membership in the text box or field 286. As should be appreciated, the text box or field 286 may be associated with a menu, for example, a drop down menu that may provide a listing of various project groups or workspaces to which the user may be associated or that the user may join. If the user enters or selects a proposed different project group or workspace, the user may select the “Accept Proposed Group” button 294 for automatically associating with the selected or proposed project group or workspace, and such proposed project group or workspace will be stored for the user, as described above. According to an embodiment, the user's feedback in response to the proposed project memberships, including entry or selection of a proposed replacement project group or workspace or membership may be used by the system 200 for enhancing its analysis of keywords or terms associated with information obtained about the user for subsequent recommendations of project group or workspace memberships.

As should be appreciated, the user interface components illustrated and described herein are for purposes of example and illustration only. The placement and orientation of textboxes, titles, buttons, functionality controls and the like in the example user interface components are not limiting of the vast number of placements and orientations that may be selected for generation and display of suitable user interface components for use as described herein.

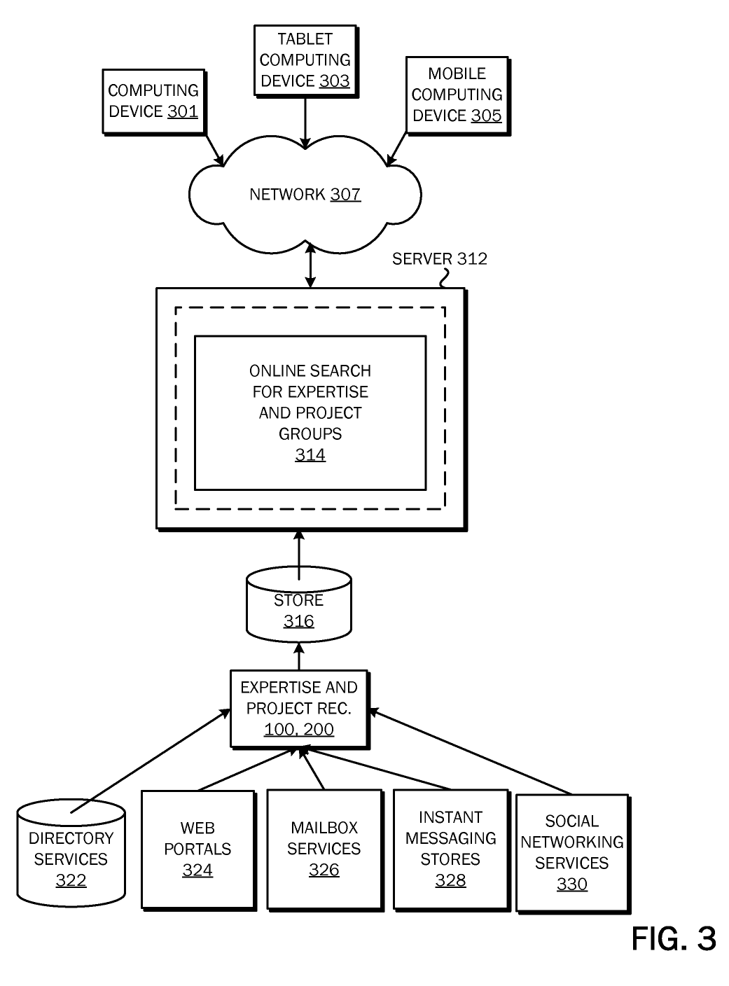

FIG. 3 illustrates a system architecture for providing expertise tags and project membership suggestions to various client devices after generation as described above. As described previously, an expertise tag system 100 may generate expertise tags and a project membership suggestion system 200 may suggest project membership from information retrieved using a variety of communication channels and stores. Information and features helpful to generating expertise tags and project membership suggestions may also be stored in different communication channels or other storage types. For example, expertise tags and project membership suggestions along with information from which they are developed may be stored using directory services 322, web portals 324, mailbox services 326, instant messaging stores 328 and social networking sites 330. The systems 100, 200 may use any of these types of systems or the like for developing expertise tags and project membership suggestions and for storing same in a store 316. A server 312 may provide expertise tags and project membership suggestions to clients. As one example, server 312 may be a web server providing expertise tags and project membership suggestions over the web. Server 314 may provide online expertise tags and project membership suggestions over the web to clients through a network 307. Examples of clients that may obtain thread summaries include computing device 301, which may include any general purpose personal computer, a tablet computing device 303 and/or mobile computing device 305 which may include smart phones. Any of these devices may obtain expertise tags and project membership suggestions/recommendations from the store 316.

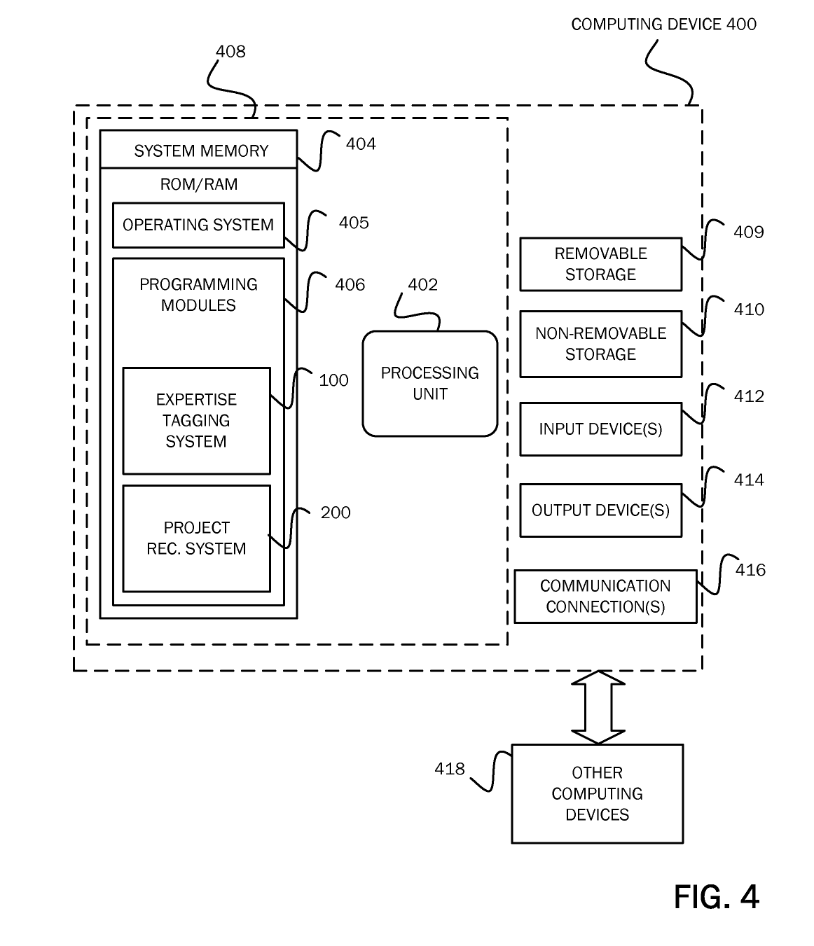

As described above, embodiments of the invention may be implemented via local and remote computing and data storage systems, including the systems illustrated and described with reference to FIGS. 1A, 1B, 2A, 2B and 3. Consistent with embodiments of the invention, the aforementioned memory storage and processing unit may be implemented in a computing device, such as computing device 400 of FIG. 4. According to embodiments, the computing device may be in the form of a personal computer, server computer, handheld computer, smart phone, tablet or slate device, or any other device capable of containing and operating the computing components and functionality described herein. In addition, the computing device components described below may operate as a computing system printed on a programmable chip. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention. Furthermore, computing device 400 may comprise operating environment 100 as described above.

With reference to FIG. 4, a system consistent with embodiments of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include the conversation topic detection, generation and storage system 200 having sufficient computer-executable instructions, which when executed, performs functionalities as described herein. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

As stated above, a number of program modules and data files may be stored in system memory 404, including operating system 405. While executing on processing unit 402, programming modules 406 and may include the expertise tag generation system 100 and the project membership suggestion/recommendation system 200 each of which may include program modules containing sufficient computer-executable instructions, which when executed, performs functionalities as described herein. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method of automatically generating and applying an expertise knowledge indication to a user, comprising:
receiving one or more text content items associated with the user;
receiving one or more metadata items associated with the user;
designating one or more of the keywords extracted from the one or more text content items or one or more metadata items as one or more expertise knowledge indications for the user; and
presenting to the user, via a computer-generated user interface component, the one or more expertise knowledge indications.

2. The method of claim 1, wherein presenting to the user, via a computer-generated user interface component, the one or more expertise knowledge indications includes presenting to the user the one or more expertise knowledge indications for acceptance the one or more of the one or more expertise knowledge indications for application to the user.

3. The method of claim 2, wherein if the user accepts the one or more of the one or more expertise knowledge indications for application to the user, associating the accepted one or more of the expertise knowledge indications with the user and storing the accepted one or more of the expertise knowledge indications in association with the user.

4. The method of claim 3, wherein if the user does not accept the one or more of the one or more expertise knowledge indications for application to the user,
receiving one or more replacement expertise knowledge indications from the user for application to the user;
associating the one or more replacement expertise knowledge indications with the user; and
storing the one or more replacement expertise knowledge indications in association with the user.

5. The method of claim 1, wherein receiving one or more text content items associated with the user includes receiving one or more text content items authored by the user; and wherein receiving one or more metadata items associated with the user includes receiving one or more metadata items associated with profile information associated with the user.

6. The method of claim 5, further comprising applying a weighting to each of the one or more text content items and the one or more metadata items for ranking each of the one or more text content items and the one or more metadata items for use as expertise knowledge indications for the user.

7. The method of claim 6, prior to designating one or more of the keywords as one or more expertise knowledge indications for the user, ranking the one or more keywords based on the weighting applied to each text content item or metadata item associated with the one or more keywords.

8. The method of claim 7, wherein designating the one or more of the keywords as one or more expertise knowledge indications for the user includes designating a highest ranked one or more of the one or more keywords as one or more expertise knowledge indications for the user.

9. The method of claim 1, further comprising:
retrieving the one or more expertise knowledge indications designated for the user;
extracting information about other users who are organizationally associated with the user;
extracting information about computing activities of the user;
extracting information about any project groups of which the user is presently a member; and
based on a correlation among the one or more expertise knowledge indications designated for the user, the information about other users who are organizationally associated with the user, the information about computing activities of the user, the information about any project groups of which the user is presently a member, and information extracted about one or more project groups, recommending membership of the user in one or more of the one or more project groups.

10. The method of claim 9, further comprising presenting to the user, via a computer-generated user interface component, the recommended membership of the user in one or more of the one or more project groups.

11. The method of claim 10, wherein presenting to the user the recommended membership of the user in one or more of the one or more project groups includes presenting to the user the recommended membership for acceptance by the user of one or more of the one or more project groups.

12. The method of claim 11, wherein if the user accepts one or more of the one or more project groups, associating the user with the accepted one or more of the one or more project groups.

13. The method of claim 12, wherein if the user does not accept one or more of the one or more project groups receiving one or more replacement project groups from the user and associating the user with the one or more replacement project groups.

14. A method of automatically recommending membership of a user in a project group, comprising:
retrieving one or more expertise tags designated for the user; and
based on a correlation among one or more expertise tags designated for the user, and one or more of information about other users who are organizationally associated with the user, information about computing activities of the user, information about any project groups of which the user is presently a member, or information extracted about one or more project groups, recommending membership of the user in one or more of the one or more project groups.

15. The method of claim 14, wherein prior to recommending membership of the user in one or more of the one or more project groups extracting information about other users who are organizationally associated with the user including parsing an organizational chart and extracting information about one or more other users listed in the organizational chart in close organizational proximity to the user.

16. The method of claim 15, wherein prior to recommending membership of the user in one or more of the one or more project groups extracting information about computing activities of the user, including extracting information about electronic documents associated with the user, the electronic documents containing keywords that may be matched against information contained in the one or more project groups.

17. A computer readable medium containing computer executable instructions which when executed by a computer perform a method of automatically generating and applying an expertise tag to a user, comprising:
receiving one or more text content items authored by the user;
receiving one or more metadata items associated with profile information associated with the user;
processing the one or more text content items and the one or more metadata items associated with the user such that text components comprising the one or more text content items and the one or more metadata items may be used for generating an expertise tag for the user;
extracting one or more keywords from the text components comprising the one or more text content items and the one or more metadata items;
designating one or more of the keywords as one or more expertise tags for the user; and
presenting to the user, via a computer-generated user interface component, the one or more expertise tags includes presenting to the user the one or more expertise tags for acceptance the one or more of the one or more expertise tags for application to the user.

18. The computer readable medium of claim 17, wherein if the user accepts the one or more of the one or more expertise tags for application to the user, associating the accepted one or more of the expertise tags with the user and storing the accepted one or more of the expertise tags in association with the user.

19. The computer readable medium of claim 18, wherein if the user does not accept the one or more of the one or more expertise tags for application to the user,
receiving one or more replacement expertise tags from the user for application to the user;
associating the one or more replacement expertise tags with the user; and
storing the one or more replacement expertise tags in association with the user.

20. The computer readable medium of claim 17, further comprising:
applying a weighting to each of the one or more text content items and the one or more metadata items for ranking each of the one or more text content items and the one or more metadata items for use as expertise tags for the user;
ranking the one or more keywords based on the weighting applied to each text content item or metadata item associated with the one or more keywords; and
wherein designating the one or more of the keywords as one or more expertise tags for the user includes designating a highest ranked one or more of the one or more keywords as one or more expertise tags for the user.
